(19) United States
(12) Patent Application Publication
(10) Pub. No.: US 2026/0352352 A1
(43) Pub. Date: Nov. 5, 2026

(54) PROPAGATION LOSS ESTIMATION METHOD, PROPAGATION LOSS ESTIMATION SYSTEM, PROPAGATION LOSS ESTIMATION DEVICE, AND PROPAGATION LOSS ESTIMATION PROGRAM

(71) Applicant: NTT, Inc., Tokyo (JP)

(72) Inventors: Minoru INOMATA, Musashino-shi, Tokyo (JP); Wataru YAMADA, Musashino-shi, Tokyo (JP); Nobuaki KUNO, Musashino-shi, Tokyo (JP)

(73) Assignee: NTT, Inc., Tokyo (JP)

(21) Appl. No.: 19/123,562

(22) PCT Filed: Oct. 27, 2022
(86) PCT No.: PCT/JP2022/040204

§ 371 Date: Apr. 23, 2025

(51) Int. Cl. H04B 17/309; H04B 17/391; H04W 16/18; H04W 24/10

(52) U.S. Cl. CPC H04B 17/347; H04B 17/391; H04W 16/18; H04W 24/10

(57) ABSTRACT

This propagation loss estimation method includes creating an outdoor 3D CAD model; extracting a profile of a piece of data concerning a terrain and a clutter between the base station and the terminal from the outdoor 3D CAD model; calculating a virtual diffraction edge based on the base station, the terminal, and the profile; and calculating a diffraction loss for radio waves passing through the virtual diffraction edge. Furthermore, the virtual diffraction edge is an intersection of a straight line whose slope is a maximum when the base station is set to be a starting point and each point of the profile is set to be an ending point and a straight line whose slope is a maximum when the terminal is set to be a starting point and each point of the profile is set to be an ending point.

### TECHNICAL FIELD

The present disclosure relates to a propagation loss estimation method, a propagation loss estimation system, a propagation loss estimation device, and a propagation loss estimation program.

### BACKGROUND ART

In terms of the use of individual wireless networks, there are an increasing number of cases in which local companies or local governments are using local 5G, Wi-Fi (registered trademark), or the like. Accordingly, there is a demand for wireless coverage evaluation which takes into account subtle changes in the terrain of outdoor local areas such as farms and construction sites, as well as the effects of detailed clutter (terrestrial features) such as vegetation.

Ray tracing methods are often used for outdoor wireless coverage evaluation. In the ray tracing methods, various propagation characteristics can be derived through calculations by defining the environment in which radio waves propagate as a 3D CAD model.

### CITATION LIST

### Non Patent Literature

Non Patent Literature 1: T. Kurner, et al. “Concepts and Results for 3D Digital Terrain-Based Wave Propagation Models: An Overview,” IEEE Journal on Selected Areas in Communications, Vol. 11, No. 7, pp. 1002-1012, September 1993.

### SUMMARY OF INVENTION

### Technical Problem

Here, in order to improve the accuracy of the analysis using the above methods, it is necessary to subdivide the 3D CAD models of the terrain and the clutter. Thus, the amount of calculations required for tracing each ray increases exponentially with the number of faces of the 3D CAD model. For this reason, there is a problem that a very large amount of calculation time is required.

In order to solve the above-described problems, a first object of the present disclosure is to provide a propagation loss estimation method which can estimate an outdoor propagation loss with high accuracy without increasing a calculation time.

Also, a second object of the present disclosure is to provide a propagation loss estimation system which can estimate an outdoor propagation loss with high accuracy without increasing a calculation time.

Furthermore, a third object of the present disclosure is to provide a propagation loss estimation device which can estimate an outdoor propagation loss with high accuracy without increasing calculation time.

In addition, a fourth object of the present disclosure is to provide a propagation loss estimation program which can estimate an outdoor propagation loss with high accuracy without increasing a calculation time.

### Solution to Problem

It is preferable that a first aspect of the present disclosure be a propagation loss estimation method which calculates an outdoor propagation loss of radio waves for each combination of a base station and a terminal, the method including: creating an outdoor 3D CAD model; extracting a profile of a piece of data concerning a terrain and a clutter between the base station and the terminal from the outdoor 3D CAD model; calculating a virtual diffraction edge on the basis of the base station, the terminal, and the profile; and calculating a diffraction loss for radio waves passing through the virtual diffraction edge, in which the virtual diffraction edge is an intersection of a straight line whose slope is a maximum when the base station is set to be a starting point and each point of the profile is set to be an ending point and a straight line whose slope is a maximum when the terminal is set to be a starting point and each point of the profile is set to be an ending point.

It is preferable that a second aspect of the present disclosure be a propagation loss estimation system which calculates an outdoor propagation loss of radio waves for each combination of a base station and a terminal, the system including: a model creation device and a propagation loss estimation device, in which the model creation device being configured to perform processing of creating an outdoor 3D CAD model, the propagation loss estimation device is configured to perform processing of extracting a profile of a piece of data concerning a terrain and a clutter between the base station and the terminal from the outdoor 3D CAD, processing of calculating a virtual diffraction edge on the basis of the base station, the terminal, and the profile, and processing of calculating a diffraction loss for radio waves passing through the virtual diffraction edge, and the virtual diffraction edge is an intersection of a straight line whose slope is a maximum when the base station is set to be a starting point and each point of the profile is set to be an ending point and a straight line whose slope is a maximum when the terminal is set to be a starting point and each point of the profile is set to be an ending point.

It is preferable that a third aspect of the present disclosure be a propagation loss estimation device which calculates an outdoor propagation loss of radio waves for each combination of a base station and a terminal by using an outdoor 3D CAD model, the device being configured to perform: processing of extracting a profile of a piece of data concerning a terrain and a clutter between the base station and the terminal from the outdoor 3D CAD model; processing of calculating a virtual diffraction edge on the basis of the base station, the terminal, and the profile; and processing of calculating a diffraction loss for radio waves passing through the virtual diffraction edge.

It is preferable that a fourth aspect of the present disclosure be a propagation loss estimation program which causes a propagation loss estimation device to calculate an outdoor propagation loss of radio waves for each combination of a base station and a terminal by using an outdoor 3D CAD model, the program causing a computer to execute: processing of extracting a profile of a piece of data concerning a terrain and a clutter between the base station and the terminal from the outdoor 3D CAD model; processing of calculating a virtual diffraction edge on the basis of the base station, the terminal, and the profile; and processing of calculating a diffraction loss for radio waves passing through the virtual diffraction edge.

### Advantageous Effects of Invention

According to the first to fourth aspects of the present disclosure, it is possible to estimate an outdoor propagation loss with high accuracy without increasing a calculation time.

### BRIEF DESCRIPTION OF DRAWINGS

FIG. 1 is a chart for describing a procedure for generating an outdoor 3D CAD model according to Embodiment 1 of the present disclosure.

FIG. 2 is a diagram showing virtual outdoor propagation paths according to Embodiment 1 of the present disclosure.

FIG. 3 is a flowchart for describing a method for estimating an outdoor propagation loss according to Embodiment 1 of the present disclosure.

FIG. 4 is a diagram showing a propagation loss estimation system according to Embodiment 1 of the present disclosure.

FIG. 5 is a diagram showing a hardware configuration of a propagation loss estimation device according to Embodiment 1 of the present disclosure.

### DESCRIPTION OF EMBODIMENTS

### First Embodiment

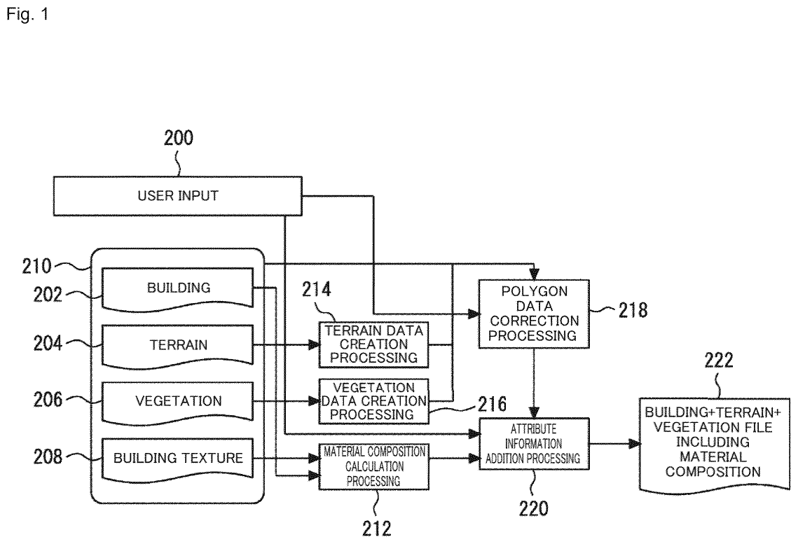

FIG. 1 is a chart for describing a procedure for generating an outdoor 3D CAD model according to Embodiment 1 of the present disclosure. In order to generate an outdoor 3D CAD model, first, a user input 200 is provided for pieces of information necessary for generating the outdoor 3D CAD model. The pieces of necessary information include, for example, a material, a cutting range, a topography capture flag, a vegetation capture flag, and the like. These pieces of information are used in polygon data correction processing 218 or attribute information addition processing 220 which will be described later.

Furthermore, a piece of specific digital data is input as a digital data input 210. Here, pieces of buildings data 202, terrain data 204, vegetation data 206, and building texture data 208 are input.

The piece of buildings data 202 and the piece of building texture data 208 are used in material composition calculation processing 212. In the material composition calculation processing 212, the piece of buildings data and the piece of material composition data are linked. For example, the material composition is directly input into each piece of buildings data included in the piece of buildings data 202. Alternatively, the material composition is automatically determined from the building texture data 208 and provided to each piece of buildings data.

The terrain data 204 is used in terrain data creation processing 214. Here, it is assumed that the piece of terrain data is in a file format having polygons, attributes, and a database. An example of the file format includes a shape file format.

The piece of vegetation data 206 is used in vegetation data creation processing 216. Here, it is assumed that the piece of terrain data is in a file format having polygons, attributes, and a database. An example of the file format includes a shape file format.

The piece of data processed in the terrain data creation processing 214 and the vegetation data creation processing 216 is used in the polygon data correction processing 218, together with information input through the user input 200 and the digital data input 210. First, the file is read. Subsequently, pieces of buildings and vegetation data are placed over the relevant terrain. Finally, cutting is performed within the user-specified range.

The piece of data processed in the polygon data correction processing 218 and the material composition calculation processing 212 is used in the attribute information addition processing 220, together with the information input by the user input 200. In the attribute information addition processing 220, a type and a material are linked. Examples of types include buildings, structure objects, and vegetation. Examples of materials include concrete, wood, the ground, and other compositions for each material.

The piece of data output from the attribute information addition processing 220 is intermediately output as a buildings+terrain+vegetation file 222 including a material composition. This is the outdoor 3D CAD model used in this disclosure.

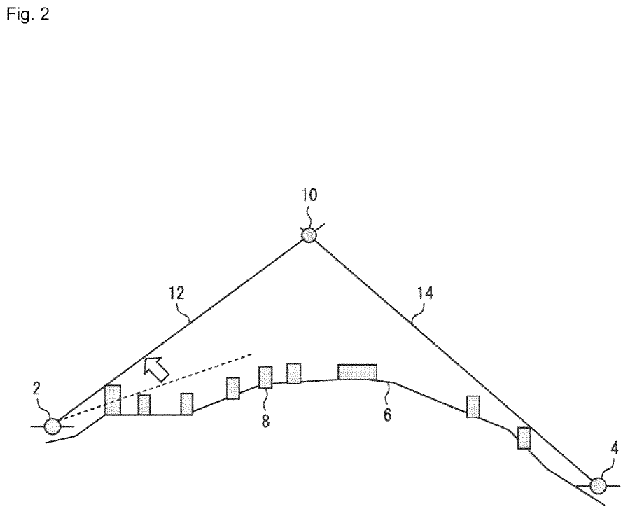

FIG. 2 is a diagram showing virtual outdoor propagation paths according to Embodiment 1 of the present disclosure. In the embodiment, an outdoor propagation loss is estimated for each combination of a Base Station (BS) and a terminal (User Equipment: UE) through calculation using information extracted from an outdoor 3D CAD model. Here, a hypothetical outdoor propagation path used at the time of calculating the outdoor propagation loss is shown.

Between the base station 2 and the terminal 4, there are a terrain 6 and a clutter 8 which act as obstacles to radio wave propagation. An example of the terrain 6 is fine terrestrial undulations on the order of several meters. Examples of the clutter 8 include buildings, structure objects, and vegetation.

In the embodiment, a virtual diffraction edge 10 is defined for estimating the outdoor propagation loss. The virtual diffraction edge 10 is defined as the intersection of a straight line 12 starting from the base station 2 and a straight line 14 starting from the terminal 4. The straight lines 12 and 14 are lines whose slopes are maxima when their starting points are the base station 2 and the terminal 4, respectively, and end points thereof are each a point on the profile of the terrain 6 or the clutter 8. That is to say, the straight lines 12 and 14 indicate the propagation paths closest to the ground among the propagation paths of radio waves which are free of obstructions.

According to the above definition, the radio wave passing through the virtual diffraction edge 10 is the radio wave with the highest signal strength among the radio waves which reach the terminal 4 from the base station 2 due to diffraction.

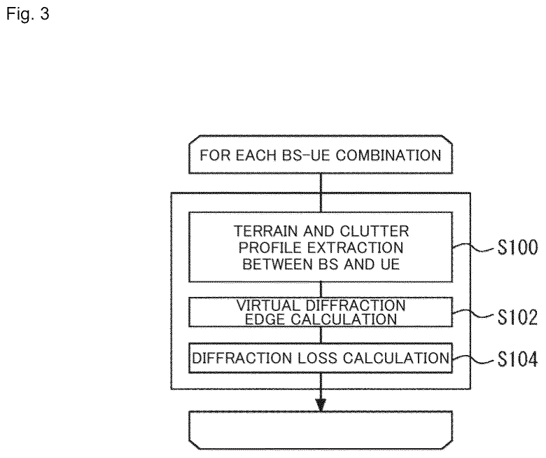

FIG. 3 is a flowchart for describing a method of estimating an outdoor propagation loss according to Embodiment 1 of the present disclosure. Here, the procedure of estimating an outdoor path loss for each combination of the base station and the terminal will be described below.

First, in Step 100, the profiles of the terrain and the cluster between the base station and the terminal are extracted. That is to say, information concerning the terrain 6 and the clutter 8 which exist between the base station 2 and the terminal 4 is extracted from a previously generated outdoor 3D CAD model.

Subsequently, in Step 102, the virtual diffraction edges are calculated. First, when the base station 2 and the terminal 4 are set as starting points and each of the points on the profile of the terrain 6 or the clutter 8 is set as an end point, a straight line with a maximum gradient is extracted. Also, the intersection point of these two straight lines is determined as the virtual diffraction edge 10.

Finally, in Step 104, the diffraction loss is calculated. That is to say, the diffraction loss is calculated based on the knife-edge diffraction theory for the radio wave passing through the virtual diffraction edge 10.

As described above, the outdoor propagation loss can be easily derived by defining a virtual diffraction edge and performing a diffraction calculation to trace rays which pass through the virtual diffraction edge. Thus, the outdoor path loss can be estimated with high accuracy without increasing a calculation time.

Note that, in the outdoor propagation loss estimation described above, in addition to the piece of data included in the outdoor 3D CAD described above, the piece of data included in the design condition file is referenced. Examples of a piece of data included in outdoor 3D CAD include a piece of data concerning buildings including material compositions, terrains, and vegetation included in a shape file.

Examples of a piece of data included in the design condition file include a piece of data relating to coordinates of the base station and the terminals, the direction of the base station, and information concerning the base station and the terminal devices.

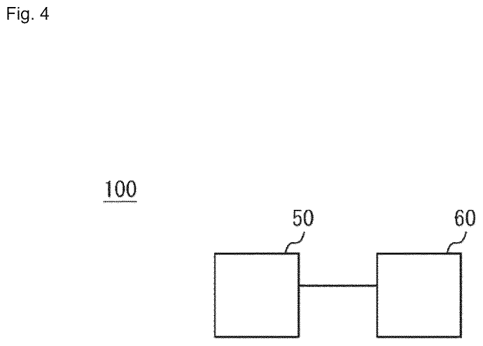

FIG. 4 is a diagram showing a propagation loss estimation system according to Embodiment 1 of the present disclosure. The propagation loss estimation system 100 is a system in which the above-described propagation loss estimation method can be performed all at once.

The propagation loss estimation system 100 includes a model creation device 50. The model creation device 50 creates the outdoor 3D CAD model described in FIG. 1.

Furthermore, the propagation loss estimation system 100 includes a propagation loss estimation device 60. The propagation loss estimation device 60 estimates the propagation loss using the propagation loss estimation procedure described in FIG. 3.

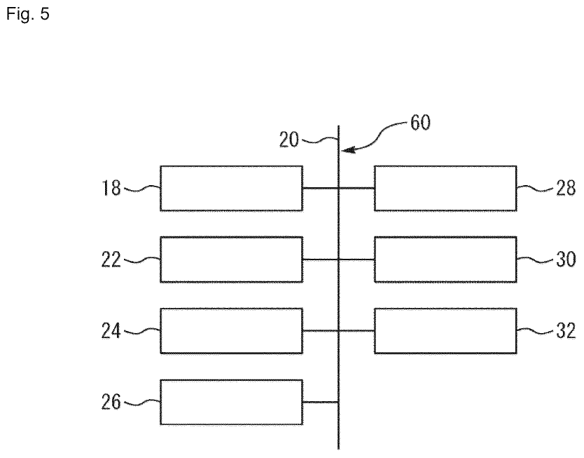

FIG. 5 is a diagram showing a hardware configuration of a propagation loss estimation device according to Embodiment 1 of the present disclosure. The propagation loss estimation device 60 includes a CPU 18. The CPU 18 is connected to a bus line 20. Memory devices such as a ROM 22, a RAM 24, and a storage 26 are connected to the bus line 20. A propagation loss estimation program executed using the CPU 18 is stored in a memory device. The propagation loss estimation device 60 realizes functions unique to the embodiment when the CPU 18 executes the propagation loss estimating program.

A communication interface 28 is also connected to the bus line 20. The propagation loss estimation device 60 realizes communication with the network via the communication interface 28. An operation part 30 and a display part 32 are further connected to the bus line 20. The operation part 30 and the display part 32 function as a user interface for handling the propagation loss estimation device 60.

As explained above, according to the propagation loss estimating method of the embodiment, unlike the conventional method, a propagation loss can be easily derived. Thus, the outdoor propagation loss can be estimated with high accuracy without increasing a calculation time.

Note that, although the propagation loss estimation device 60 executes the processing necessary for propagation loss estimation in Embodiment 1 described above, the present disclosure is not limited to this. For example, the propagation loss estimation program may be provided to the service provision PC and the service provision PC may execute the processing.

### REFERENCE SIGNS LIST

2 Base station
4 Terminal
6 Terrain
8 Clutter
10 Virtual diffraction edge
12 Straight line
14 Straight line
50 Model creation device
60 Propagation loss estimation device
100 Propagation loss estimation system

1. A propagation loss estimation method which calculates an outdoor propagation loss of radio waves for each combination of a base station and a terminal, the method comprising:
creating an outdoor 3D CAD model;
extracting a profile of a piece of data concerning a terrain and a clutter between the base station and the terminal from the outdoor 3D CAD model;
calculating a virtual diffraction edge on the basis of the base station, the terminal, and the profile; and
calculating a diffraction loss for radio waves passing through the virtual diffraction edge,
wherein the virtual diffraction edge is an intersection of
a straight line whose slope is a maximum when the base station is set to be a starting point and each point of the profile is set to be an ending point and
a straight line whose slope is a maximum when the terminal is set to be a starting point and each point of the profile is set to be an ending point.

2. The propagation loss estimation method according to claim 1, wherein the clutter is
at least one of buildings, structure objects, and vegetation.

3. A propagation loss estimation system which calculates an outdoor propagation loss of radio waves for each combination of a base station and a terminal, the system comprising:
a model creator and a propagation loss estimator
wherein the model creator is
configured to perform: processing of creating an outdoor 3D CAD model,
the propagation loss estimator is configured to perform
processing of extracting a profile of a piece of data concerning a terrain and a clutter between the base station and the terminal from the outdoor 3D CAD,
processing of calculating a virtual diffraction edge on the basis of the base station, the terminal, and the profile, and
processing of calculating a diffraction loss for radio waves passing through the virtual diffraction edge, and
the virtual diffraction edge is an intersection of
a straight line whose slope is a maximum when the base station is set to be a starting point and each point of the profile is set to be an ending point and
a straight line whose slope is a maximum when the terminal is set to be a starting point and each point of the profile is set to be an ending point.

4. A propagation loss estimator which calculates an outdoor propagation loss of radio waves for each combination of a base station and a terminal by using an outdoor 3D CAD model, the estimator being configured to perform:
processing of extracting a profile of a piece of data concerning a terrain and a clutter between the base station and the terminal from the outdoor 3D CAD model;
processing of calculating a virtual diffraction edge on the basis of the base station, the terminal, and the profile; and
processing of calculating a diffraction loss for radio waves passing through the virtual diffraction edge.

5. A storage medium storing a computer readable propagation loss estimation program configured to cause a computer to execute the propagation loss estimation method according to claim 1.
